(19) United States
(12) Patent Application Publication
(10) Pub. No.: US 2026/0091907 A1
(43) Pub. Date: Apr. 2, 2026

(54) BLANK FOR PACKAGING A FOOD PORTION AND METHOD FOR PACKAGING A FOOD PORTION

(71) Applicant: BEL, Suresnes (FR)

(72) Inventors: Camille LECOINTE, Suresnes (FR); Gilles COUPARD, Suresnes (FR); Luc FAVIER, Suresnes (FR); Victor DA PONTE, Suresnes (FR)

(73) Assignee: BEL, Suresnes (FR)

(21) Appl. No.: 19/136,729

(22) PCT Filed: Dec. 5, 2023
(86) PCT No.: PCT/EP2023/084396

§ 371 Date: Jun. 6, 2025

(30) Foreign Application Priority Data
Dec. 9, 2022 (FR) FR2213089

(51) Int. Cl. B65D 5/20; B31B 50/26

(52) U.S. Cl. CPC B65D 5/2042; B31B 50/26

(57) ABSTRACT

A blank having fold lines that define: a triangular bottom panel, two quadrilateral side panels two triangular top panels, a back panel and a border that has two outer strips to form a sealing backing and two front strips that are arranged so as to form, as an extension from the backing, a sealing tab, a tear line being arranged so that manually pulling on the tab causes the blank to tear from the apex of the bottom panel to the top panel and then on either side of said top panel.

The invention concerns a blank for packaging a food portion, as well as a method for packaging a food portion using such a blank.

It applies in particular to the packaging of individual food portions of fresh dairy products, such as fresh and/or melted cheese, which are packaged in a prismatic envelope with a triangular base formed by folding a blank.

To benefit from an ecologically designed packaging, the blank according to the invention is preferably formed from a complex comprising an outer layer based on cellulose fibers and an inner sealing layer.

To obtain a prismatic envelope with a triangular base, blanks provided with fold lines are known, which are arranged so as to define:
a bottom panel with a triangular geometry, intended to form a bottom wall of the envelope;
two side panels of quadrilateral geometry, each having an inner edge connected by a fold line to a respective outer long side of the bottom panel, said side panels being intended to form a respective side wall of the envelope;
two top panels each having a triangular geometry with a large inner edge which is connected by a fold line to a respective outer side of a side panel, said top panels being intended to form together an upper wall of the envelope;
a back panel having an inner edge which is connected by a fold line to a back edge of the bottom, side and top panels, said back panel being intended to form a back wall of the envelope.

The blank also comprises a border having two outer strips each having an inner edge which is connected by a fold line to a respective large outer edge of a top panel, said outer strips being arranged to be sealed to each other to form a sealing backing for the top wall of the envelope.

The sealing backing ensures that the package is watertight but, particularly in relation to a blank comprising a cellulosic layer, there is the problem of how easy it is to open the packaging so that the portion can be consumed, especially by young children and/or for soft portions.

In particular, opening and/or tearing the backing requires packaging handling which, in addition to being ergonomically complex, is too constraining to preserve the integrity of the portion.

The invention aims to improve the prior art by proposing a blank, in particular comprising a cellulosic layer, for packaging a food portion, said blank making it possible to combine optimum sealing with good opening ergonomics, in particular in relation to ease of opening for young children and/or the packaging of a soft portion.

To this end, according to a first aspect, the invention proposes a blank for packaging a food portion comprising fold lines allowing the shaping of said blank into a prismatic envelope with a triangular base in which said portion can be packaged before closing said envelope, said fold lines defining a blank having:
a bottom panel with a triangular geometry intended to form a bottom wall of the envelope;
two side panels of quadrilateral geometry, each having an inner edge connected by a fold line to a respective outer long side of the bottom panel, said side panels being intended to form a respective side wall of the envelope;
two top panels each having a triangular geometry with a large inner edge which is connected by a fold line to a respective outer side of a side panel, said top panels being intended to form together a top wall of the envelope;
a back panel having an inner edge which is connected by a fold line to a back edge of the bottom, side and top panels, said back panel being intended to form a back wall of the envelope;
a border having two outer strips each having an inner edge which is connected by a fold line to a respective large outer edge of a top panel, said outer strips being arranged to be sealed to each other to form a sealing backing for the top wall of the envelope; the blank further having two front strips each having a back edge which is connected by a fold line to a front edge of respectively an outer strip and a side panel, said front strips having a common inner edge formed by a fold line extending in the extension of the apex of the bottom panel, said front strips being arranged to be sealed to each other to form, as an extension from the backing, a sealing tab of the tip of the package, the blank comprising a tear line having two side segments which each extend respectively over a top panel and along the outer edge of the adjacent side panel, while each being extended by a front segment which extends, in continuity with said side segment and beyond said outer edge, on the adjacent side panel and towards the apex of the bottom panel, said tear line being arranged so that manual pulling on the sealing tab causes the blank to tear along its tip from the top of the bottom panel to the top panel, followed by propagation of said tear on either side of the top wall.

According to a second aspect, the invention proposes a method for packaging a food portion by means of such a blank, said method providing for:
folding the blank along its fold lines to form a prismatic envelope with a triangular base that has a bottom wall, two side walls, a top wall and an open back mouth;
sealing the outer and front strips of the border to form a sealing backing for the top wall of the envelope and a sealing tab for the tip of the package;
packaging the portion in the package through the back mouth;
closing said mouth tightly.

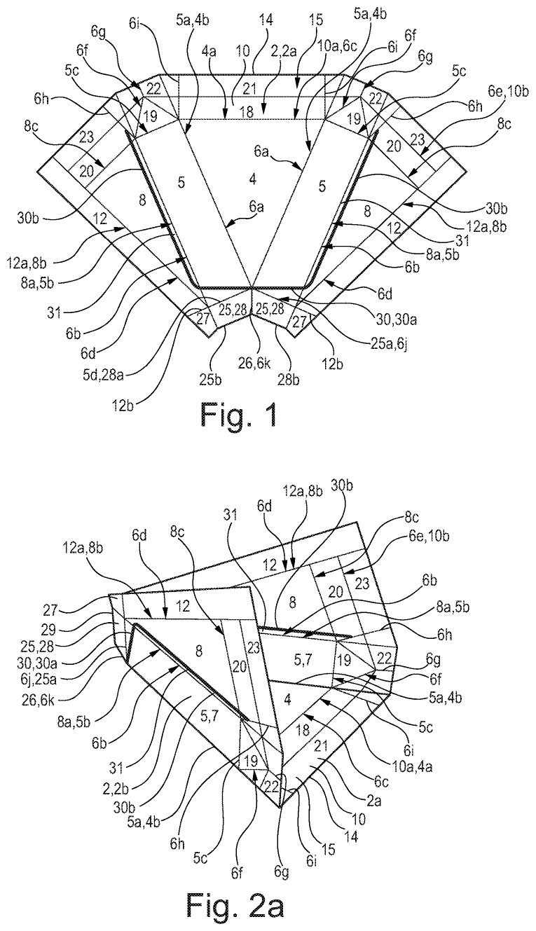

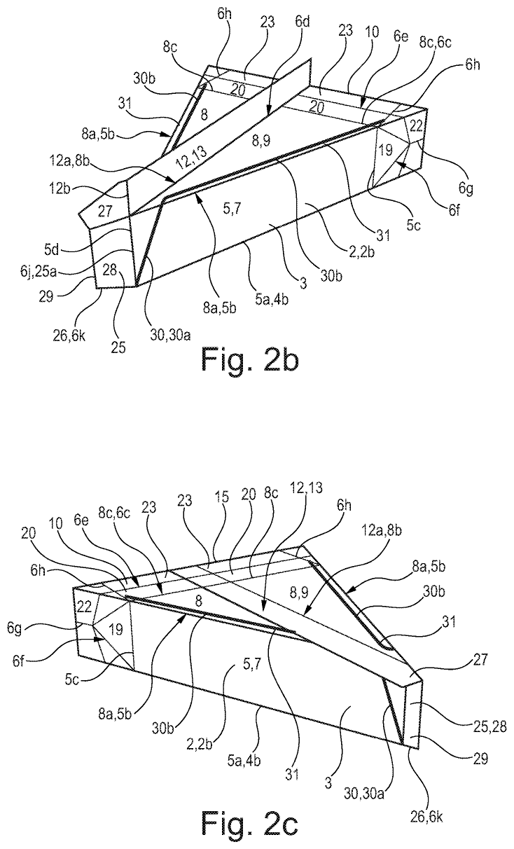

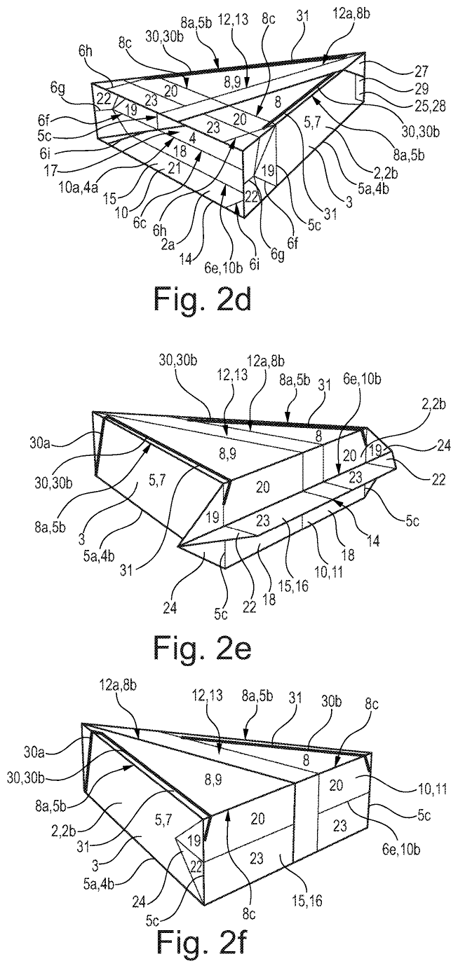

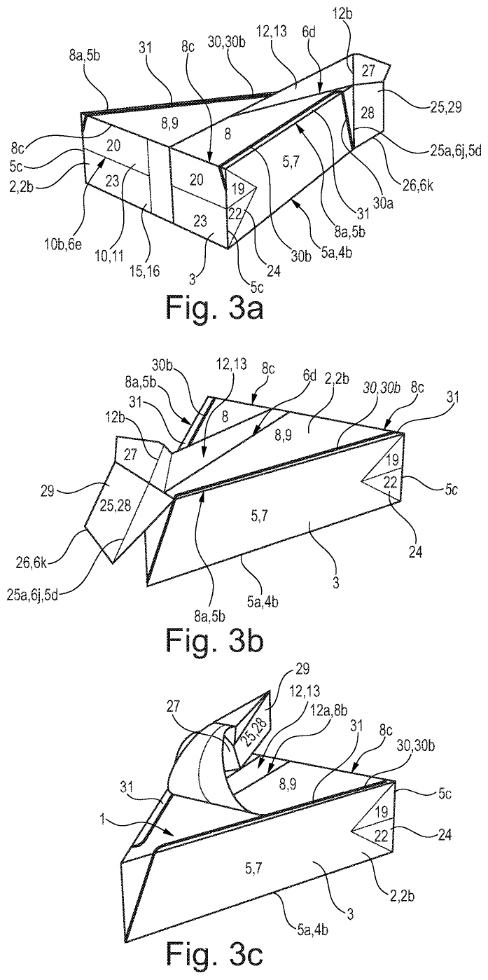

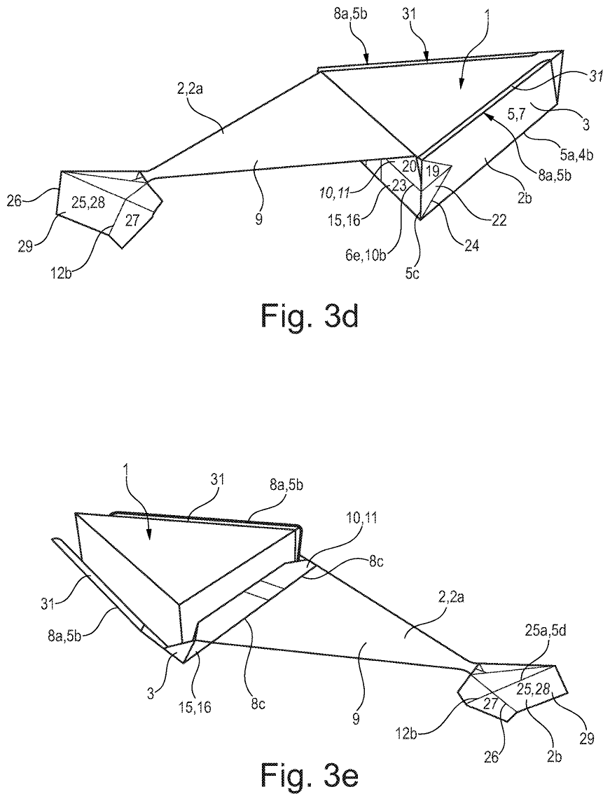

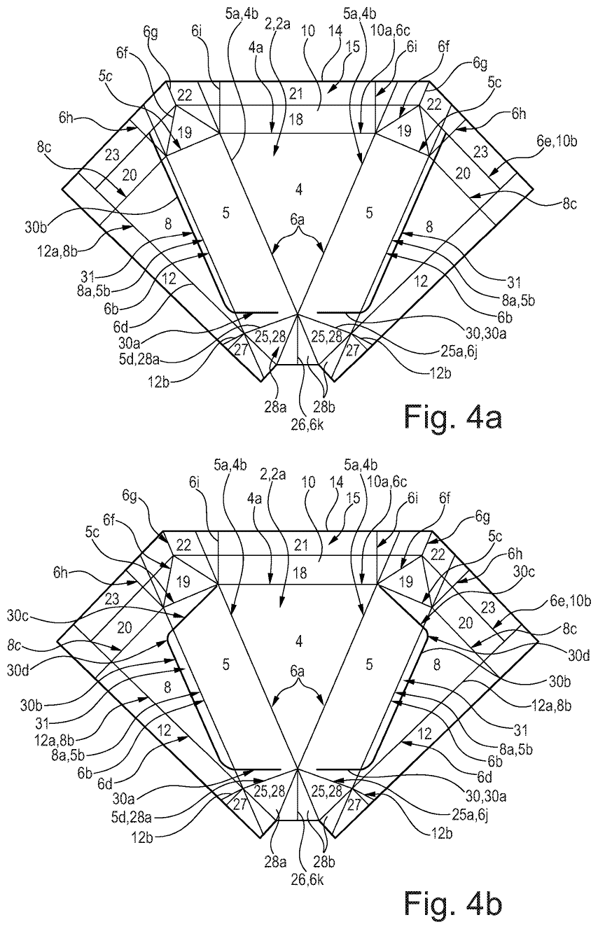

Further features and advantages of the invention will become apparent from the following description, made with reference to the appended figures, in which:
FIG. 1 shows a schematic view of a blank according to the invention before its folding, from a front view and from the inside thereof;
FIGS. 2a to 2f show perspective views, from different orientations, of the blank of FIG. 1 during the various steps of its folding to form a package;
FIGS. 3a to 3e show perspective views, from different orientations, different steps for opening the package shown in FIG. 2f;
FIGS. 4a and 4b show schematically, in a view analogous to FIG. 1, a blank according to respectively a variant of the embodiment of the previous figures.

In connection with these figures, a blank for packaging a food portion 1 is described below, as well as a method for packaging a food portion 1 by means of such a blank.

The blank is particularly suitable for packaging a single portion of fresh dairy product, such as fresh and/or melted cheese.

The blank is formed by a complex 2 which has a sealing layer 2a with oxygen and/or water vapor barrier properties, so as to ensure the preservation of the packaged food portion 1.

The sealing layer 2a can be made of a food-grade plastic material, particularly if it is intended to come into contact with the food portion 1 packed in the package. For that purpose, the sealing layer 2a can be made from polyethylene (PE) and/or polyethylene terephthalate (PET), or from other known types of food-grade plastics, such as polyamide (PA), polypropylene (PP) or polylactic acid (PLA). Advantageously, the complex 2 comprises an inner sealing layer 2a as described above, as well as an outer layer 2b based on cellulosic fibers. In particular, the cellulosic fibers may be derived from wood and shaped by a paper-making process to form a layer of paper or cardboard, or they may be in the form of a non-woven fabric.

Such an arrangement makes it possible to benefit from an ecologically designed package. In particular, the outer layer 2b can be made from recycled cellulosic fibers.

According to an example, the outer layer 2b has a mass per unit area of between 30 g/m² and 150 g/m², in particular of between 50 g/m² and 110 g/m², and more particularly of the order of 80 g/m².

Advantageously, the complex 2 comprises between 60% and 90% by weight of cellulosic fibers. To this end, the outer layer 2b can have a thickness of the order of 60 μm, and the inner layer 2a a thickness of between 4 μm and 20 μm.

To improve the overall sealing properties of the package, the complex 2 may comprise at least one additional layer of film and/or varnish with suitable properties, particularly as an oxygen and/or water vapour barrier. In particular, the outer face of the outer layer 2b can be coated with an additional varnish layer with anti-condensation properties.

The complex 2 may present decorations and/or markings, for example aesthetic and/or commercial motifs and/or inscriptions linked to the food portion 1. These elements may be formed by printing and/or embossing directly on the outer cellulosic fiber layer 2b.

A method for packaging a food portion 1 in a blank formed in a complex 2 as described above is now described.

The method provides at first for forming fold lines 6a-6k on the blank, that are arranged to allow to shape said blank into a triangular-based prismatic envelope 3, into which the food portion 1 can be packed before closing said envelope to form a package.

Advantageously, these fold lines 6a-6k are formed by creasing the outer cellulosic fiber layer 2b, which allows to facilitate the folding of the blank while preserving the integrity of the sealing layer 2a.

In relation to the figures, the method provides for forming fold lines 6a-6k on the blank, so as to define thereon:
a bottom panel 4 with a triangular geometry and intended to form a bottom wall of the envelope 3;
two side panels 5 of quadrilateral geometry, each having an inner edge 5a connected by a fold line 6a to a respective outer long side 4b of the bottom panel 4, and each intended to form respectively a side wall 7 of the envelope 3;
two top panels 8 each having a triangular geometry with a large inner edge 8a which is connected by a fold line 6b to a respective outer side 5b of a side panel 5, said top panels being intended to form together a top wall 9 of the envelope 3;
a back panel 10 having an inner edge 10a which is connected by a fold line 6c to a respective back edge 4a, 5c, 8c of the bottom 4, side 5 and top 8 panels, said back panel being intended to form a back wall 11 of the envelope 3; and
a border with two outer strips 12, each of which has an inner edge 12a connected by a fold line 6d to a respective large outer edge 8b of a top panel 8, said outer strips being arranged to be sealed together to form a sealing backing 13 for the top wall 9 of the envelope 3.

The bottom panel 4 has a geometry in the shape of an isosceles triangle, the base of which forms the back edge 4a, which is defined by the fold line 6c separating said bottom panel from the back panel 10.

Each top panel 8 has a geometry in the shape of a right-angled triangle, the hypotenuse of which forms the large inner edge 8a that defines the fold line 6b between said top panel and the adjacent side panel 5. Similarly, for each top panel 8:
the long side 8b forming the right angle of said triangle is defined by the outer fold line 6d with respect to the adjacent outer strip 12; and
the perpendicular short side 8c is defined by the back fold line 6c of said top panel with respect to the back panel 10.

The outer strips 12 of the border extend to the back edge 14 of the blank, and the border has a back strip 15 extending between the back ends of said outer strips and along the entire back edge 14 of said blank, said back strip being connected by a fold line 6e to a back edge 10b of the back panel 10, and being arranged to be sealed on itself to form a hem 16 for sealing the back wall 11 of the package. Referring to FIGS. 2a and 2b, the packaging method provides for folding the blank along its fold lines 6a, 6b, 6c, 6d, 6e to form a triangular-based, prismatic envelope 3 with a bottom wall, two side walls, a top wall and an open back mouth. To do so, the method provides for successively folding:
the lines 6a defining the large outer sides 4b of the bottom panel 4, so as to erect the side panels 5 to form the side walls 7 of the envelope 3 (FIG. 2a)
the lines 6b defining the respective outer sides 5b of the side panels 5, so as to fold the top panels 8 over the bottom panel 4 to form the top wall 9 of the envelope;
the lines 6d defining the respective large outer edges 8b of the top panels 8, so as to erect the outer strips 12 of the border with their respective inner faces against each other (FIG. 2b).

In particular, after these folding steps, an envelope 3 is obtained with an open back mouth 17 (FIG. 2d), and the inner face of the back strip 15 of the border delimits an inner periphery of said back mouth.

The method then provides for sealing the outer strips 12 of the border, so as to form a sealing backing 13 for the top wall 9 of the envelope 3.

To achieve this, the method provides for depositing a layer of adhesive on the respective inner faces of the outer strips 12, so as to form the sealing backing 13 by “flesh-flesh” sealing of said outer strips.

The adhesive can be hot melt or cold glue, so as to ensure a permanent and watertight seal of the backing 13.

In particular, as the outer strips 12 extend to the back edge 14 of the blank, their sealing allows to obtain a sealing backing 13 that closes the periphery of the back mouth 17.

Then, as shown in FIGS. 2c and 2d, the backing 13 is folded over the top wall 9 of the envelope 3 after it has been sealed.

The method then provides for packing the food portion 1 into the package through the back mouth 17, then folding the back panel 10 to close said mouth.

In this way, the method enables to form a mold by means of the envelope 3, into which the food portion 1 can be poured in liquid or viscous form before closing said envelope, thereby limiting production costs by dispensing with an additional step of shaping said food portion prior to packaging in the package.

This arrangement also makes it possible to produce packaged food portions 1 in a more hygienic way and with better preservation conditions. Indeed, by pouring the food portion 1 directly into its individual package, its exposure to the ambient air is limited, thus reducing the risk of contamination, particularly by germs. Moreover, if the food portion 1 is poured at a temperature higher than the pasteurization temperature, which allows to improve all the more its preservation properties.

To fold the back panel 10, the method provides for extending the fold lines 6a, 6b, 6d defining the outer edges 4b, 5b, 8b and inner edges 5a, 8a of the bottom 4, side 5 and top 8 panels on said back panel so as to form bottom 18, side 19 and top 20 sectors thereon, said folding being performed by folding side sectors 19 flat, so as to fold down top 20 and bottom 18 sectors, as shown in FIG. 2e.

In order to reseal the mouth 17, the method then provides for:
folding the back strip 15 flat, by placing a top portion of the inner face of said back strip on a bottom portion of said inner face;
sealing the inner face of the back strip 15, by a flesh-flesh association of its top and bottom portions, so as to form the sealing hem 16 of the back wall 11.

In particular, this embodiment enables continuous sealing of the inner face of the back strip 15, guaranteeing optimum tightness, in particular thanks to the absence of any excess thickness in said sealing.

To enable the back strip 15 to be sealed, the method provides at first for applying a layer of adhesive to its inner face, in particular an adhesive similar to that applied to the outer strips 12 of the border to form the top sealing backing 13.

In the embodiment shown, the method provides for extending the fold lines 6a, 6b, 6d of the back panel 10 onto the back strip 15 of the border, so as to form bottom 21, side 22 and top 23 sectors on said back strip, in the back extension of the corresponding sectors 18, 19, 20 of said back panel.

Thus, as shown in FIGS. 2d and 2e, the back band 15 is folded flat by placing the inner face of the top sectors 23 on the inner face of the bottom sector 21, and by folding the inner face of each of the side sectors 22 onto itself.

In particular, the various folding lines 6a, 6b, 6d are extended in a straight line, making it easier to produce the blank and fold the envelope 3.

The method provides for forming a pattern 6f of fold lines on the respective side sectors 19, 22 of the back panel 10 and of the back strip 15, said pattern being arranged to enable said sectors to be folded flat.

In particular, as shown in FIGS. 1, 2a, 2b, 2c and 2d, each fold line pattern forms a triangle 6f extending over the side sector 19 of the back panel 10, the base of the triangle 6f being formed by the front edge of the side sector 19 and the apex of said triangle being disposed on the back edge of said side sector, said apex being extended by a fold line 6g extending over the side sector 22 of the back strip 15 to the back edge 14 of said back strip.

The method further provides for forming:
on each of the top sectors 20, 23: a fold line section 6h extending from the intersection between the front edge and the inner edge of the top sector 20 of the back panel 10 to the back edge 14 of the blank; and
on the bottom sectors 18, 21: two fold line sections 6i extending from the intersection between the front edge 10a of the back panel 10 and respectively one of the outer edges of its bottom sector 18 to the back edge 14 of the blank.

Referring to FIGS. 2e and 2f, the various fold line patterns 6f and sections 6h, 6i formed on the side sectors 19 of the back panel 10 allow said side sectors to be folded in order to form two side gussets 24 of triangular geometry, which are then folded over onto a respective side wall 7.

In particular, after sealing the back strip 15, the sealing hem 16 thus formed is folded over a bottom portion of the back wall 11 of the envelope 3, and the side gussets 24 are then each folded over the adjacent side wall 7.

As an alternative, not shown, the back mouth 17 can be sealed by folding the side sectors 19 flat into triangular gussets 24 towards the inside of the package and on either side of the back wall 11 of the envelope 3, then, after sealing the back strip 15, by folding the sealing hem 16 over said back wall.

To facilitate opening of the package, particularly by young children and/or in connection with a soft food portion 1, the method provides for forming the fold lines so that the border further has two front strips 25, each of which has a back edge 25a connected by a fold line 6j to a front edge 12b, 5d of respectively an outer strip 12 and a side panel 5, as well as a common inner edge 26 formed by a fold line 6k extending in continuation of the apex of the bottom panel 4.

Advantageously, as shown in FIGS. 1, 4a and 4b, the blank is symmetrical with respect to the axis defined by the common inner edge 26 of the front strips 25 (vertical in FIG. 1), which allows to facilitate manufacture of said blank and folding of the envelope 3.

Each of the fold lines 6b defining the inner edges 8a of the top panels 8 extends to the front edge 25b of the front strip 25, while forming, on either side of said line, an outer sector 27 in the extension of an outer strip 12 and an inner sector 28 delimited with the common inner edge 26.

In particular.
each of the inner sectors 28 has a back edge 28a formed by a fold line 6j and a free front edge 28b, said edges being parallel; and
the apex of each of the top panels 8 opens out at the intersection between the adjacent outer 27 and inner 28 sectors.

Alternatively, as shown in FIGS. 4a and 4b, each of the fold lines 6a, 6d, which respectively defines the large outer sides 4b of the bottom panel 4 and the respective large outer edges 8b of the top panels 8, also extend to the front edge 25b of the adjacent front strip 25a, so as to form in the inner sector 28 of said front strip:
a triangular central sub-sector 28a;
two side sub-sectors 28b on either side of said central sub-sector.

In relation to FIG. 2b, the front strips 25 are arranged to be sealed to each other so as to form, in the extension of the backing 13, a tab 29 for sealing the tip of the package.

To do so, the method provides for applying a layer of an adhesive, in particular similar to that used on the backing 13 and the back hem 16, to the inner face of the front strips 25 of the border, so as to enable the tab 29 to be formed by “flesh-flesh” type sealing of said front strips.

As shown in FIGS. 2c and 2d, after sealing the top backing 13 and the front tab 29, the method provides for:
folding the backing 13 over the top wall 9 of the envelope 3, so that the top part of the tab 29, which is formed by sealing the outer sectors 27, is arranged horizontally;
folding the bottom part of said tab, which is formed by sealing the inner sectors 28, onto a side wall 7; and
folding said top part over said side wall, by partially overlapping said bottom part of the tab 29.

The method further provides for forming a tear line 30 on the blank, which has two side segments 30b, each extending respectively over a top panel 8 and along the outer edge 5b of the adjacent side panel 5, and each being extended by a front segment 30a which extends, in continuity with said side segment and beyond said outer edge, over the adjacent side panel 5 and towards the apex of the bottom panel 4.

The tear line 30 is arranged so that manually pulling on the sealing tab 29 causes the blank to tear along its tip from the apex of the bottom panel 4 to the top panel 8, followed by propagation of said tear on either side of the top wall 9.

In this way, the blank makes it possible to provide the consumer with a package with a rigid tab 29 of which the large dimensions make it easier to grip digitally, said tab also forming a lever arm to facilitate the initiation of tearing of said package along the line 30 formed for that purpose in said package.

In FIG. 1, the tear line 30 comprises a single front segment 30a that extends over the side panels 5 from the apex of the bottom panel 4 to beyond the outer edge 5b of each of said side panels.

Alternatively, as shown in FIGS. 4a and 4b, the tear line 30 comprises two distinct front segments 30a, separated by a blank section devoid of said tear line which extends over the apex of the bottom panel 4. This arrangement makes it possible to avoid the presence of a tearable zone at the front tip of the envelope 3 after folding, in order to limit the risk of food product 1 leaking at said tip through untimely rupture of such a tearable zone.

In particular.
the front segment(s) 30a of the tear line 30 extend(s) parallel to a back edge 4a of the bottom panel 4;
each side segment 30b of the tear line 30 extends parallel to a respective outer edge 5b of the corresponding side panel 5.

This arrangement enables the consumer to open the package on the front tip and the top wall 9 of the envelope 3, and in particular on either side of the sealing backing 13. In this way, the consumer does not need to tear the backing 13 to open the package, thus guaranteeing the tightness of said backing during storage of the packaged food portion 1 and facilitating access to said food portion when opening its package.

Advantageously, the side segments 30b of the tear line 30 delimit between them and on the top wall 9 of the envelope 3 a tearable zone of which the surface area is greater than at least 80%, and in particular greater than 95%, of the total surface area of said top wall.

To do so, each side segment 30b extends in particular over more than 90% of the length of the adjacent outer edge 5b, while having an intrinsic length that remains less than 100% of said outer edge length, in order to guarantee separation of the tip from the rest of the package when it is opened.

In this way, the tear line 30 allows to form a large opening in the envelope 3, so as to facilitate extraction of the food portion 1 from the package.

In particular, each side segment 30b of the tear line 30 extends along the outer edge 5b, by forming a band 31 between them, so that, after the package has been opened, each band 31 rests on a top wall of the food portion 1, so as to hold against it a side wall 7 of the envelope 3, to which it is attached. This arrangement enables the food portion 1 to be wedged laterally against the bottom wall of the envelope 3, pending its removal by the consumer, as shown in FIG. 3d.

Each of the bands 31 has a width which is less than 10% of the width of the adjacent side panel 5, and in particular less than 5% of said width. This arrangement facilitates extraction of the food portion 1 by the consumer, who then simply has to spread the side walls 7 (FIG. 3e) to be able to remove said food portion from the bottom wall the envelope 3 while retaining its integrity of shape, particularly in the case of a soft food portion 1.

In FIGS. 1 and 4a, each lateral segment 30b of the tear line 30 extends rectilinearly to the back edge 8c of a respective top panel 8, and extends in particular over the back panel 10, by preferably opening into the fold line section 6h of the adjacent top sector 20.

Thus, by continuing to pull on the tab 29, the consumer can tear part, but not all, of the back wall 11 of the envelope 3, so as to hold the food portion 1 between the untorn portion of the back wall 11 and the side walls 7, pending extraction of said food portion from the package by said consumer.

According to a variant shown in FIG. 4b, the tear line 30 has two back segments 30c, each of which extends a respective side segment 30b, each back segment 30c extending rectilinearly over the adjacent side panel 5 to an end facing the junction between the inner fold lines 6i, 6f of the corresponding back side sector 19.

In particular, each side tear segment 30b is connected to the corresponding front segment 30a and/or back 30c segment by a bend 30d of curved geometry, said bends each having a radius of curvature which is arranged to ensure tearing along said segments.

In addition, the bottom panel 4 has no tear line, so that it remains integral with the envelope 3 after the package has been opened, thus forming a tray on which the food portion 1 can be held while pending to be picked up by the consumer. According to one embodiment, the tear line 30 is obtained by partial precutting of the blank thickness, in particular by ablation of material, to a depth sufficient to form a line of weakening enabling the tearing of said blank to be guided along said line. Advantageously, the line 30 can be formed by laser cutting of different parameters at the bends 30d connecting segments 30a, 30b and/or 30c, in order to facilitate tearing along said bends.

To preserve the integrity of the inner layer 2a, and therefore the sealing of the package, the tear line 30 is formed by at least partial ablation of only the outer layer 2b.

Advantageously, the tear line 30 is formed, for example by laser or mechanical cutting, over approximately ⅘ of the total thickness of the outer layer 2b, which provides a good compromise between preserving the sealing of the package and facilitating its opening by tearing along said line.

In a further embodiment, the tear line 30 allows the tearing of the blank to be guided without prior pre-cutting of said blank, for example by means of a fold or groove line of the blank, and/or by a particular orientation of the fibers of the outer layer 2b along said line.

1. A blank for packaging a food portion comprising fold lines allowing the shaping of said blank into a prismatic envelope with a triangular base in which said portion can be packaged before closing said envelope, said fold lines defining a blank having:
a bottom panel with a triangular geometry intended to form a bottom wall of the envelope
two side panels of quadrilateral geometry each having an inner edge which is connected by a fold line to a respective large outer side of the bottom panel said side panels being intended to form a respective side wall of the envelope
two top panels each having a triangular geometry with a large inner edge which is connected by a fold line to a respective outer edge of a side panel said top panels being intended to form together a top wall of the envelope;
a back panel having an inner edge which is connected by a fold line to a back edge of the bottom side and top panels, said back panel being intended to form a back wall of the envelope
a border having two outer strips each having an inner edge which is connected by a fold line to a respective large outer edge of a top panel said outer strips being arranged to be sealed to each other to form a sealing backing of the top wall of the envelope
wherein the border further has two front strips each having a back edge which is connected by a fold line to a front edge of respectively an outer strip and a side panel said front strips having a common inner edge formed by a fold line extending in the extension of the apex of the bottom panel said front strips being arranged to be sealed to each other to form, in the extension of the backing a sealing tab of the tip of the package, and in that the blank comprises a tear line having two side segments which each extend respectively over a top panel and along the outer edge of the adjacent side panel by each being extended by a front segment which extends, in continuity with said side segment and beyond said outer edge, on the adjacent side panel and towards the apex of the bottom panel said tear line being arranged so that manually pulling on the sealing tab causes said blank to tear along its tip from the apex of the bottom panel to the top panel followed by propagation of said tear on either side of the top wall.

2. The blank for packaging a food portion according to claim 1, wherein the tear line comprises a single front segment which extends over the side panels from the apex of the bottom panel to beyond the outer edge of each of said side panels.

3. The blank for packaging a food portion according to claim 1, wherein each side segment of the tear line extends parallel to a respective outer edge.

4. The blank for packaging a food portion according to claim 1, wherein each side segment of the tear line extends along the outer edge by forming a band between them.

5. The blank for packaging a food portion according to claim 1, wherein each side segment of the tear line extends to the back edge of a respective top panel.

6. The blank for packaging a food portion according to claim 5, wherein each side segment of the tear line extends over the back panel.

7. The blank for packaging a food portion according to claim 1, wherein each of the fold lines defining the inner edges of the top panels extends to the front edge of the front strip, while forming, on either side of said line, an outer sector in the extension of an outer strip and an inner sector delimited with the common inner edge.

8. The blank for packaging a food portion according to claim 7, wherein each of the inner sectors has a back edge formed by a fold line and a free front edge, said edges being parallel.

9. The blank for packaging a food portion according to claim 1, wherein the fold lines defining the outer edges and inner edges of the bottom, side and top panels extend, in particular rectilinearly, on the back panel to form bottom side and top sectors on said back panel.

10. The blank for packaging a food portion according to any claim 1, wherein the border has a back strip which is connected by a fold line to a back edge of the back panel said back strip being arranged to be sealed onto itself to form a sealing hem of the back wall of the package.

11. The blank for packaging a food portion according to claim 9, wherein the back strip has bottom side and top sectors in the back extension of the corresponding sectors of the back panel the side sectors of the back panel and of the back strip each having a pattern of fold lines which is arranged to enable the back strip to be sealed flat.

12. The blank for packaging a food portion according to claim 9, wherein each of the top sectors has a fold line section extending from the intersection between the front edge and the inner edge of the top sector of the back panel to the back edge of the blank.

13. The blank for packaging a food portion according to claim 12, wherein each of the side segments of the tear line opens into the corresponding fold line section.

14. The blank for packaging a food portion according to claim 1, wherein it is formed from a complex comprising an outer layer based on cellulosic fibers and an inner sealing layer.

15. The blank for packaging a food portion according to claim 14, wherein the tear line is formed by at least partial ablation of only the outer layer.

16. The blank for packaging a food portion according to claim 14, wherein the fold lines are formed by creasing the outer layer.

17. A method for packaging a food portion using the blank according to claim 1, said method providing for:
folding the blank along its fold lines to form a prismatic envelope with a triangular base that has a bottom wall, two side walls, a top wall and an open back mouth.
sealing the outer and front strips of the border to form a sealing backing on the top wall of the envelope and a sealing tab on the tip of the package;
packing the portion in the package through the back mouth; and
closing said mouth tightly.
